(19) United States
(12) Patent Application Publication
(10) Pub. No.: US 2006/0207105 A1
(43) Pub. Date: Sep. 21, 2006

(54) Hair clipper blade with cooling fins

(76) Inventors: Armando Alvite, Miami Lakes, FL (US); Octavio Alen, Boca Raton, FL (US)

Correspondence Address: Lawrence J. Shurupoff;Sunbeam Products, Inc., 2381 Executive Center Drive, Boca Raton, FL, 33431, US

(21) Appl. No.: 11/082,077

(22) Filed: Mar. 16, 2005

(51) Int. Cl. B26B 19/00

(52) U.S. Cl. 30/225; 30/123

(57) ABSTRACT

A hair cutter blade in biased slideable contact with the upper or rear surface of a clipper comb is adapted to be reciprocated back and forth by an electric hair clipper. The upper surface of the clipper comb includes a plurality of cooling depressions and cooling protrusions effective in increasing the surface area of the upper surface of the clipper comb so as to substantially reduce temperatures during operation of the clipper blade. Air currents formed by the clipper blade convectively cool the depressions and protrusions so as to efficiently transfer heat from the lower surface of the clipper comb through the protrusions to the ambient air.

### BACKGROUND OF THE DISCLOSURE

1. Field of the Disclosure

The present invention relates to a method and apparatus for removing heat from electric clipper blade assemblies of the type used in hair grooming.

2. Description of the Related Art

A common issue with modem electric hair clippers is that the rate of reciprocation of the cutting blade is typically high enough to cause significant increases in the temperature of the clipper blade and clipper comb. Because the clipper comb is in direct contact with a person or animal being shaved, a hot comb can result in discomfort to the subject. It is not unusual for the clipper comb to reach temperatures of 100° F. or more within just 7 or 8 minutes of continuous use. Much of this is due to the friction between the reciprocating clipper cutter blade and stationary clipper comb which together form a clipper head assembly.

What is needed is a hair clipper blade assembly for electric hair clippers that heats up at a substantially slower rate as compared to conventional designs and cools down at a substantially faster rate than conventional designs. Also desired is a hair clipper blade assembly which does not get as hot as conventional clipper designs after prolonged use.

### BRIEF SUMMARY OF THE DISCLOSURE

The present invention is directed to a hair clipper having a cutter blade in slideable contact with the upper or interior surface of a clipper comb. The blade is adapted to be reciprocated back and forth against the upper surface of the clipper comb by an electric motor. The upper surface of the clipper comb includes a plurality of cooling depressions and cooling protrusions which increase the surface area of the upper surface of the clipper comb so as to substantially increase convective cooling and thereby reduce the temperature of the clipper comb during and after operation of the clipper blade assembly. In effect, the large surface area created by the depressions and protrusions draws heat away from the exterior surface of the clipper comb so as to reduce its running temperature.

In another aspect of the invention, the cooling depressions are formed as a plurality of grooves spaced a distance apart, the spacing between the grooves defining the cooling protrusions.

In another aspect of the invention, the cooling depressions are formed as a plurality of cross-cut grooves spaced a distance apart on the interior or upper surface of a clipper comb.

In another aspect of the invention, the cross-cut grooves extend perpendicularly to the cooling grooves or depressions.

In another aspect of the invention, the cross-cut grooves extend diagonally with respect to the cooling grooves or depressions.

In another aspect of the invention, the surface area of the upper surface of the clipper comb is increased by at least about 50%, as compared to an ungrooved upper surface, via formation of grooves and protrusions.

### BRIEF DESCRIPTION OF THE DRAWINGS

FIG. 1 is a top perspective view of a clipper blade assembly constructed in accordance with a first embodiment of the invention and mounted upon an electric hair clipper.

FIG. 2 is an exploded side view of the clipper blade assembly of the invention.

FIGS. 3a and 3b are top plan views of the clipper blade assembly of the invention showing the reciprocating action of the cutter.

FIG. 4a is a top plan view of the clipper blade assembly of FIG. 3b rotated 90°.

FIG. 4b is a side view of the clipper comb in FIG. 4a.

FIGS. 5a and 5b are respective bottom plan and top plan views of the clipper comb of FIG. 4b.

FIG. 6 is a perspective view of the clipper blade assembly of FIG. 1.

FIG. 7 is a perspective rear view of the clipper comb of FIG. 5b.

FIG. 8 is a top schematic perspective view of a second embodiment of the clipper head of the invention.

FIG. 9 is a top schematic perspective view of a third embodiment of the clipper head of the invention.

In the various views of the drawings, like reference numerals designate like or similar parts.

### DETAILED DESCRIPTION OF THE PREFERRED EMBODIMENTS

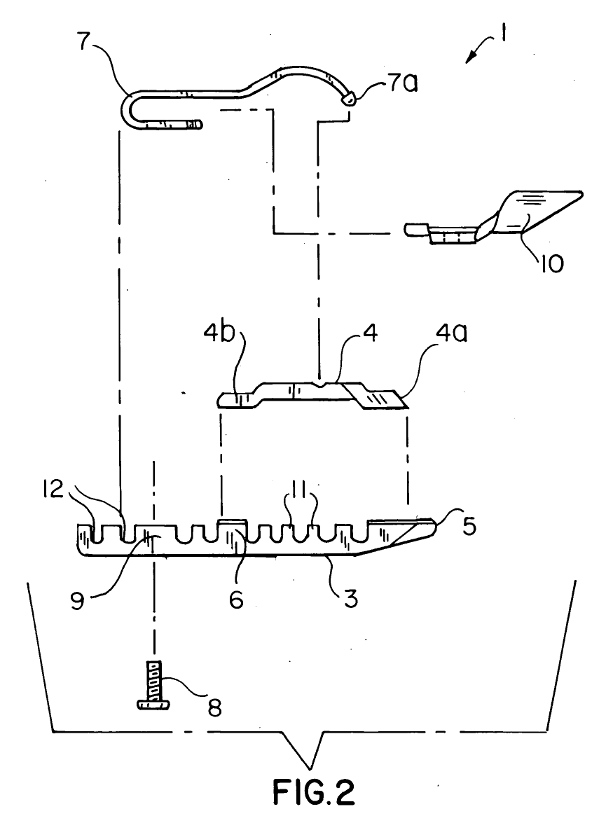

FIG. 2 depicts a clipper blade set or clipper blade assembly 1 constructed in accordance with the present invention and mounted on an electric hair clipper 2. The clipper blade set 1 has a clipper comb 3 having a plurality of comb teeth 5 that are run through hair like a comb and cut the hair when the electric hair clipper 2 is activated. Within the electric hair clipper 2 is an electric motor that drives a cutter blade 4 in a known fashion.

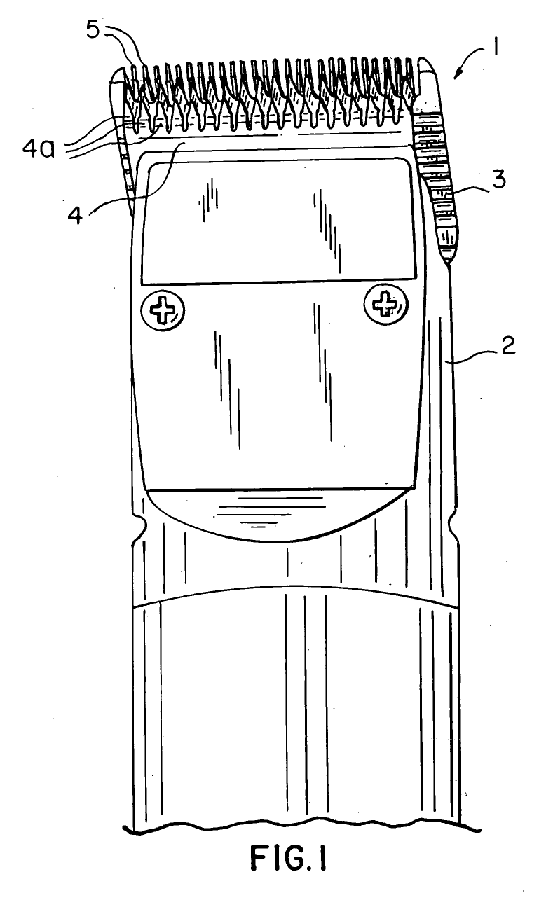

Referring to FIG. 2, there is shown an exploded side plan view of the clipper blade set 1 of FIG. 1. A cutter blade 4 is resiliently and slideably pressed against a stationary clipper comb 3 by a spring member 7. The cutter blade 4 contacts the clipper comb 3 along two rail-like surfaces. A rear cutter blade rail 4b makes slideable contact with a slide rail 6 on the inner surface of the clipper comb 3, while the cutter blade's scissor teeth 4a are in slideable contact with the comb teeth 5 of the clipper comb 3.

Typically, the spring member 7 will exert several pounds of downward force upon the cutter blade 4. The spring member 7 may include a low friction blade guide 7a to reduce sliding friction with the cutter blade 4. Typically, the blade guide 7a will be made of a polymer material, such as a polytetraflouroethelene material or a nylon material. Particularly useful materials are molybdenum disulphide (MoS2) filled nylons.

The spring member 7 may be fixedly attached to a spring rail 9 by any convenient attachment, such as one or more screws 8. Also shown is an attachment member 10, which may be fitted within the spring member 7 and attached to the clipper head 5 along with the spring member 7 with the same set of screws 8. The attachment member 10 is shaped and designed in a conventional manner to allow the clipper blade assembly 1 to be mounted on the electric hair clipper 2 (FIG. 1).

Also shown in FIG. 2 are a plurality of cooling protrusions, ridges or fins 11 and cooling depressions or grooves 12 that increase the upper surface area of the clipper comb 3 as compared to an ungrooved or flat upper surface. The area of the upper or inner surface of the clipper comb 3 is increased to an extent that the rate of increase of temperature of the clipper comb 3 is substantially reduced during use by convective heat transfer and the rate of cooling of the clipper comb 3 is substantially increased when the clipper is turned off.

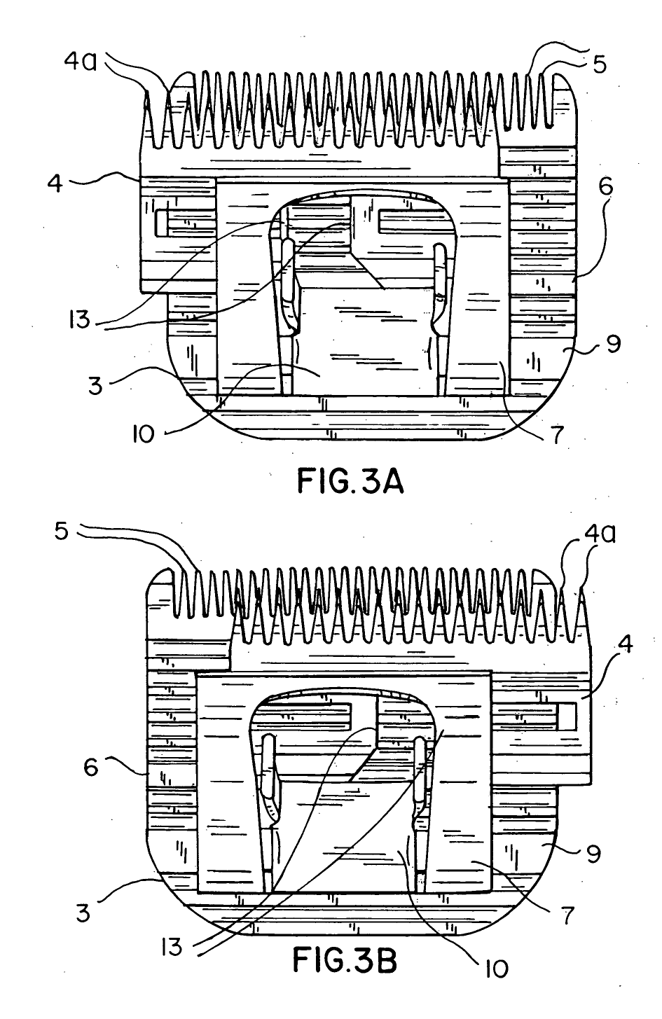

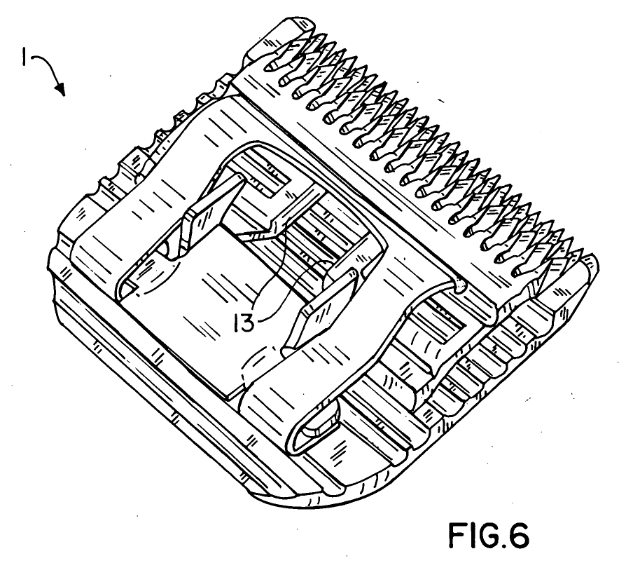

FIGS. 3a and 3b show the reciprocating action of the cutting blade 4, to the left and right, respectively. The cutting blade 4 slides on the inner surfaces of the comb teeth 5 and on slide rail 6 of the clipper comb 3. Through an opening between the legs of the U-shaped spring member 7 can be seen an opening or slot defined between a pair of inner vertical abutment edges 13 of the cutter blade 4. This opening receives a transversely reciprocating driving shaft from the electric motor. The reciprocating motion of the drive shaft against the edges 13 causes the cutter blade 4 to slide rapidly side to side in a known fashion. A perspective view of the clipper blade assembly 1 and abutment edges 13 are shown in FIG. 6.

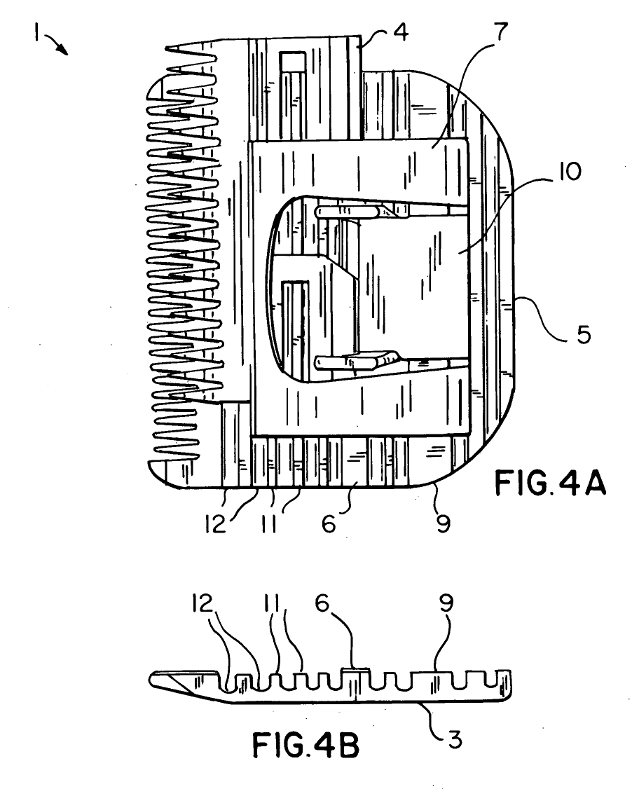

Referring to FIG. 4a, there is shown a top plan view of the clipper blade assembly 1 in relation to a side plan view of the clipper comb 3 shown in FIG. 4b. In the embodiment shown in FIGS. 4a and 4b, the cooling protrusions 11 are formed as rails or ridges extending transversely across the width of the clipper comb 3 and parallel to the movement or stroke path of the clipper cutter blade 4. The cooling depressions 12 are formed as grooves, depressions or open channels. The clipper comb 3 can be constructed by taking a standard clipper comb and machining cooling grooves across its inner or rear surface so as to increase the surface area enough to substantially increase convective cooling and thereby reduce the temperature of the clipper comb during and after operation.

Generally, the increase in surface area created by the protrusions 11 and grooves 12 will be at least 50% and preferably 100% greater than that of a corresponding ungrooved conventional clipper comb. The thickness of the clipper comb 3 places a limitation on how deep the cooling depressions 12 can be. A typical clipper comb is about ⅛ inch thick. If one cuts grooves 1/16 inch deep, spaced 1/16 inch apart, one may easily double the surface area where the grooves are present without significantly weakening the structural integrity of the clipper comb 3.

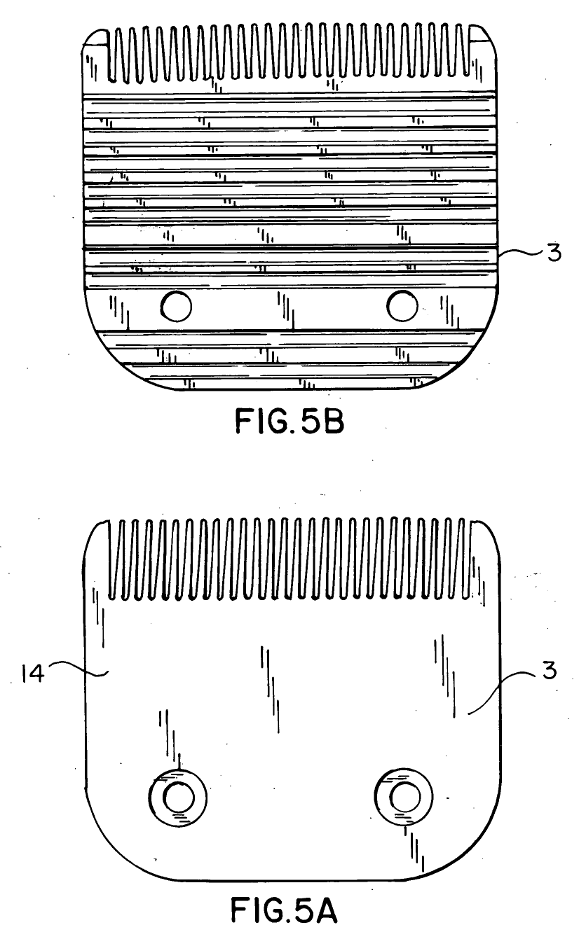

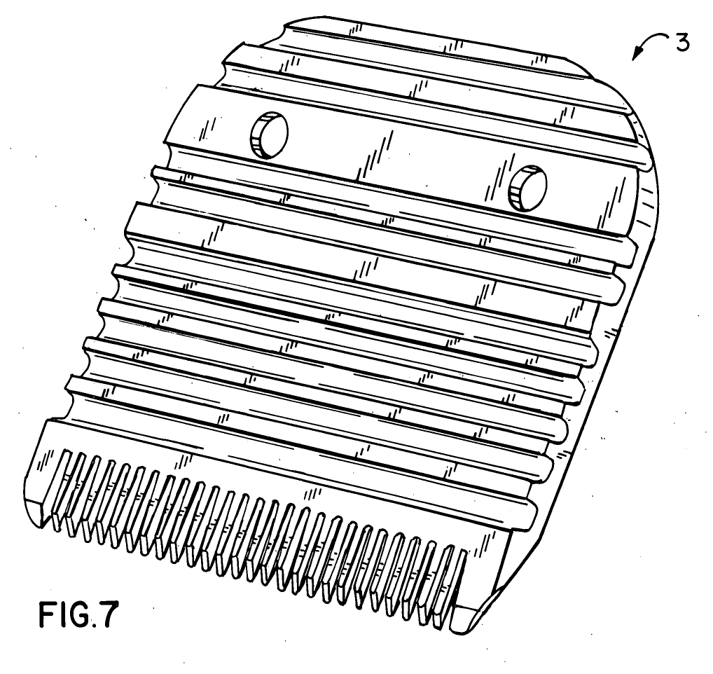

As seen in FIG. 5a, the bottom or outer exposed surface 14 of the clipper comb 3 (the surface in contact with the subject being shaved) is smooth and the upper or interior surface of the clipper comb 3 is grooved (FIG. 5b). A perspective view of the clipper comb 3 is shown in FIG. 7.

The significance of increasing the surface area of the upper surface of the clipper comb 3 is that the reciprocating motion of the cutter blade 4 drags or fans air back and forth and thereby causes air currents to form adjacent to the inner surface of the clipper comb 3 and flow across the cooling protrusions 11 and cooling grooves 12, thereby resulting in a forced convection. The rate of heat transfer is directly proportional to the area of the surface being cooled. Doubling the surface area generally doubles the rate of heat transfer.

Another factor to consider is the turbulence of the fluid flow over the surface to be cooled. The more turbulent the flow, the better the cooling. This is because a straight and smooth flow is generally laminar, and the transfer of heat from the surface to successively higher flow layers is essentially by the relatively slow process of heat conduction. By introducing turbulence, packets of fluid containing energy from direct contact with the hot surface are physically transported across air layer boundaries. The greater the turbulence, the thinner the boundary layer is and the greater the rate of heat transfer. The formation of peg-shaped protrusions, as noted below, encourages the generation of turbulent air flow across the inner surface of the comb.

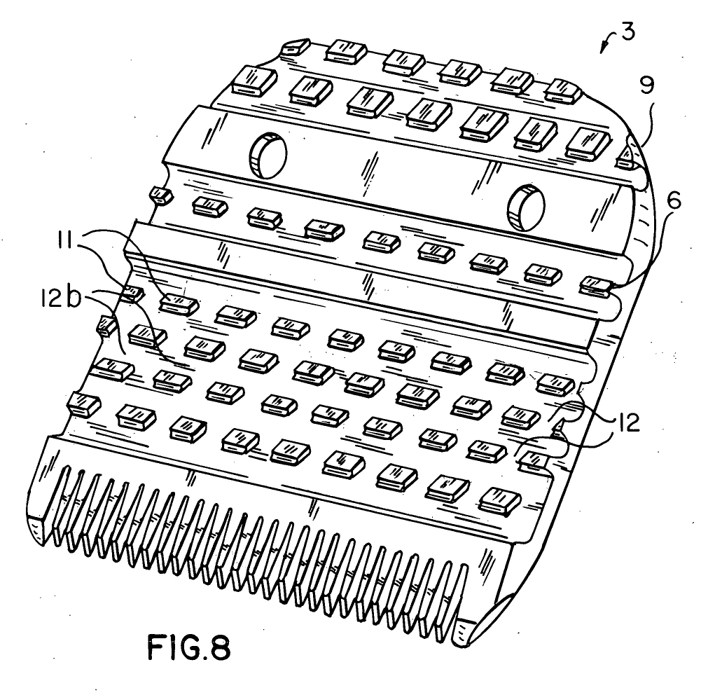

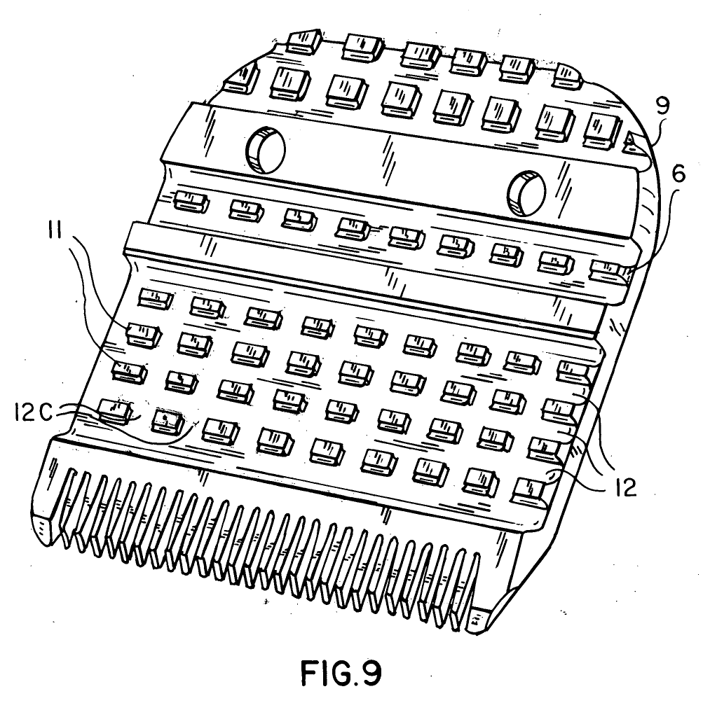

FIGS. 8 and 9 diagrammatically show two alternative embodiments to further increase surface area and turbulence across the top of the clipper head 5. In FIG. 8, a plurality of diagonal grooved cooling depressions 12b are cross-cut across the original horizontal groove cooling depressions 12 of FIG. 5b to form a plurality of diamond or rhombus-shaped peg-like cooling protrusions 11. In FIG. 9, the cross-cut cooling depressions 12c are vertical walled grooves, forming a plurality of square-shaped or rectangular peg-like cooling protrusions 11. The cooling protrusion and depression patterns shown in any of the embodiments of the invention may be achieved by known manufacturing techniques, such as milling, casting, stamping, grinding, EDM and other known machining methods.

Experiments performed with grooved clipper combs 3 have shown significant results. A size 10 clipper comb was modified by cutting 1/16 inch deep grooves 1/16 inches apart as represented in FIG. 5b. The cutting blade 4 and clipper comb 3 of this example were made of AISI 1080 steel. After repeated runs of 30 minutes, it was found that, at steady state running temperatures, the modified grooved clipper comb was 13° to 25° cooler than a conventional corresponding clipper comb without cooling grooves, ridges or protrusions. The clipper comb not only took longer to reach its steady state temperature, but also cooled down faster than conventional clipper combs. Moreover, because the steady state running temperature of the modified clipper comb was less than that of equivalent ungrooved clipper blades, subjects being shaved did not experience uncomfortable heating from the clipper combs.

While various values, scalar and otherwise, may be disclosed herein, it is to be understood that these are not exact values, but rather to be interpreted as “about” such values, unless explicitly stated otherwise. Further, the use of a modifier such as “about” or “approximately” in this specification with respect to any value is not to imply that the absence of such a modifier with respect to another value indicated the latter to be exact.

Changes and modifications can be made by those skilled in the art to the embodiments as disclosed herein and such examples, illustrations, and theories are for explanatory purposes and are not intended to limit the scope of the claims. Further, the abstract of this disclosure is provided for the sole purpose of complying with the rules requiring an abstract so as to allow a searcher or other reader to quickly ascertain the subject matter of the disclosures contained herein and is submitted with the express understanding that it will not be used to interpret or to limit the scope or the meaning of the claims.

What is claimed is:

1. A hair clipper blade assembly, comprising:
a clipper comb having an exterior surface and an interior surface;
a cutter blade slideable adjacent to said interior surface of said clipper comb and adapted to be reciprocated back and forth adjacent to said interior surface of said clipper comb; and
a plurality of cooling depressions and cooling protrusions provided on said interior surface of said clipper comb for increasing surface area of said interior surface of said clipper comb so as to substantially reduce temperature of said clipper comb during operation of said clipper blade assembly.

2. The assembly of claim 1, wherein said cooling depressions are formed as a plurality of grooves spaced a distance apart, the spacing between said grooves defining said cooling protrusions.

3. The assembly of claim 2, wherein said cooling depressions are formed as a plurality of cross-cut grooves spaced a distance apart.

4. The assembly of claim 3, wherein said cross-cut grooves are aligned perpendicularly with respect to each other.

5. The assembly of claim 4, wherein said cross-cut grooves are aligned diagonally with respect to each other.

6. The assembly of claim 1, wherein said cooling protrusions are formed as peg-shaped protrusions.

7. A clipper comb, comprising:
an exterior surface for contacting a subject during grooming; and
an interior surface adapted to be frictionally coupled to a clipper blade, and wherein said interior surface has a larger surface area than said exterior surface so as to increase heat transfer from said interior surface and thereby cool said exterior surface.

8. A method of cooling a clipper comb, comprising:
forming a plurality of protrusions on an interior surface of said clipper comb;
reciprocating a cutter blade over said interior surface so as to form air currents around said protrusions; and
cooling an external surface of said clipper comb by transferring heat from said protrusions to ambient by convection of heat from said protrusions.
